(19) United States
(12) Patent Application Publication
(10) Pub. No.: US 2012/0180875 A1
(43) Pub. Date: Jul. 19, 2012

(54) FLOW LIMITER

(75) Inventors: Urs Keller, Hinwil (CH); Jorg Kuhne, Jona (CH)

(73) Assignee: BELIMO HOLDING AG, Hinwil (CH)

(21) Appl. No.: 13/378,806

(22) PCT Filed: Jul. 14, 2010
(86) PCT No.: PCT/CH2010/000180

§ 371 Date: Feb. 1, 2012

(30) Foreign Application Priority Data
Jul. 14, 2009 (CH) 01100/09

(51) Int. Cl. G05D 7/01

(52) U.S. Cl. 137/12; 138/43

(57) ABSTRACT

A flow limiter for limiting a volumetric flow through a liquid line, comprising a carrier having a passage and a flat spring attached to the carrier. The flat spring has a spring tongue and the passage has an opening, wherein the spring tongue is above the opening such that the spring tongue increasingly lies against the carrier as differential pressure rises, thereby reducing the opening and continuously reducing the passage within a defined pressure range. A body is arranged upstream of the spring tongue, or the spring tongue is oriented in the flow direction so that the spring tongue offers a direct contact surface to a substantially reduced flow cross-section. Thus the spring tongue is deflected, or rested against the carrier, to a lesser extent at low differential pressure values so that at a low differential pressure, a constant volumetric flow rate and an expanded operating range having a constant volumetric flow rate is achieved.

### TECHNICAL FIELD

The present invention relates to a flow limiter for limiting a volumetric flow through a liquid line. The present invention relates particularly to a flow limiter which has a carrier with a passage and a flatform spring attached to the carrier, the flatform spring being set up to come to bear increasingly against the carrier with a rising differential pressure and at the same time to reduce the size of the orifice.

### PRIOR ART

Flow limiters or flow rate controllers limit the volumetric flow through a liquid line, for example a pipeline, within a defined working range of the differential pressure and thus make it possible to have a constant volumetric flow through the line independently of pressure changes in the line.

The patent specification GB 783,323 describes a flow limiter which comprises a round flatform spring fastened, centered, to a carrier of round configuration. The carrier has a multiplicity of small round orifices which are arranged on two concentric rings symmetrically about the center of the carrier and which determine the maximum passage. With an increase in liquid pressure in the pipeline, the flatform spring is flattened, so that the open region between pipeline and flatform spring is reduced. According to GB 783,323, the flattening of the spring is not linear with respect to the increasing pressure, because the flattening commences at the center and progresses outward, and because the round configuration of the spring has the effect that the non-flattened region decreases rapidly toward the marginal region with increasing flattening. In the flow limiter according to GB 783,323, the overall passage orifice is limited by the annularly arranged perforations which, moreover, have an increased risk of soiling and clogging due to their small size. Furthermore, there is an increased tendency to oscillation when, with an increasing flattening of the flatform spring, the individual holes are closed individually and the overall passage is thereby reduced in steps.

U.S. Pat. No. 4,884,750 discloses a flow limiter for limiting a volumetric flow through a liquid line, which has a carrier with a passage and a bent spring which is attached to the carrier and is set up to be flattened increasingly with a rising differential pressure (Δp). The various forms of the springs either have the disadvantage of an insufficient volumetric flow or start to oscillate when the passage is increasingly closed.

WO 2009/062997 describes a flow limiter for limiting a volumetric flow through a liquid line, which comprises a carrier with a passage and a flatform spring attached to the carrier. The flatform spring has at least one spring tongue and the passage has at least one orifice. The spring tongue is configured and arranged above the orifice such that the spring tongue comes to bear increasingly against the carrier with a rising differential pressure and at the same time reduces the orifice and reduces the passage within a defined pressure range.

GB 2 231 940 describes a flow controller for washing machines, which comprises a fixed carrier element with orifices which can be partially covered by plastic elements. The plastic elements are designed as round disks which are arranged so as to be lifted off from the carrier element at their center. With an increasing pressure, the plastic elements bend in the direction of the carrier element with their outer marginal regions facing away from the center, so that they form a curved screen over the orifices. According to GB 2 231 940, two such plastic elements are arranged concentrically and at a defined distance one above the other, the lower plastic element having a larger diameter than the upper plastic element. Moreover, the lower plastic element is provided with orifices which, when the upper plastic element is being bent in the direction of the carrier element, are covered in an screen-like manner.

### PRESENTATION OF THE INVENTION

An object of the present invention is to propose a flow limiter for limiting a volumetric flow through a liquid line, which does not have at least some of the disadvantages of the prior art. In particular, an object of the present invention is to propose a flow limiter which, as compared with the prior art, has a lower risk of soiling and a lower tendency to oscillation. In particular, a further object of the present invention is to propose a flow limiter which generates a constant volumetric flow within an extended pressure range.

According to the present invention, these aims are achieved, in particular, by means of the elements of the independent claims. Further advantageous embodiments may also be gathered from the dependent claims and the description.

The flow limiter for limiting a volumetric flow through a liquid line comprises a carrier with a passage (passage orifice) and a flatform spring attached to the carrier. The flatform spring comprises at least one spring tongue and the passage comprises at least one orifice. In this case, the spring tongue is configured and arranged above the orifice such that, with a rising differential pressure, the spring tongue comes to bear increasingly against the carrier and at the same time reduces the size of the orifice and reduces the passage within a defined pressure range.

The abovementioned aims are achieved by the present invention, in particular, in that the spring tongue is preceded by a body or the spring tongue is oriented in the direction of flow such that the spring tongue offers a direct attack surface to a flow cross section which is reduced by at least 25%. In other words, the spring tongue is preceded by a body or the spring tongue is oriented in the direction of flow such that the spring tongue is exposed directly to a reduced cross-sectional part of the flow which amounts to less than 75% of the surface of the spring tongue. The flow cross section to which the spring tongue offers a direct attack surface increases in size with the rising differential pressure when the spring tongue comes to bear increasingly against the carrier. Since the spring tongue is exposed to the direct flow to a lesser extent at low differential pressure values, that is to say, in particular, in the essentially deflection-free initial position, this affords the advantage that the spring tongue is deflected or brought to bear against the carrier to a lesser extent at low differential pressure values, and consequently the passage is reduced less (quickly) at low differential pressure values, so that a nominal throughflow, that is to say a constant volumetric flow value, is obtained even in the case of a lower differential pressure and therefore an extended working range with a constant volumetric flow value is achieved.

Preferably, the spring tongue and the corresponding orifice have in each case an essentially identical extent along a longitudinal direction. Since the orifice is dimensioned correspondingly to the size of the spring tongue, an overall larger passage and a reduced risk of soiling, as compared with the prior art, can be achieved for the comparable size of the flow limiter. In other words, with the same overall passage, the flow limiter can be designed to be more compact and less susceptible to dirt. Moreover, since the spring tongue is brought to bear against the carrier increasingly with a rising differential pressure, a nonlinear increase in the spring resistance in the case of a rising pressure is achieved, but at the same time a tendency to oscillation which is reduced, as compared with the prior art, is achieved due to the resulting continuous reduction in size of the passage.

In one design variant, at a low differential pressure of the defined pressure range, the spring tongue is oriented in the direction of flow such that the majority of the spring tongue runs in the direction of flow and the spring tongue offers a direct attack surface to a reduced flow cross-sectional part which amounts to less than 75% of the surface of the spring tongue, preferably a flow cross-sectional part of between 8% and 25% of the spring tongue surface. If the spring tongue is straight in the flow-free initial position, the spring tongue has correspondingly an angle of less than 45°, preferably an angle in the range of approximately 5° to approximately 15°, with respect to the longitudinal axis of the liquid line.

In one design variant, the carrier has a ramp rising opposite to the direction of flow and the spring tongue is configured such that, with a rising differential pressure, it is bent increasingly and comes to bear against the ramp, and at the same time continuously reduces the size of the orifice and continuously reduces the passage within the defined pressure range.

In one design variant, the body preceding the spring tongue is set up and arranged such that, at a low differential pressure of the defined pressure range, it generates a flow shadow (projection shadow) for at least a surface part of 25% of the spring tongue, preferably for a surface part in the range of 90% to 100% of the spring tongue. In this case, the carrier is in essentially planar configuration and the spring tongue is configured such that, with a rising differential pressure, it is increasingly flattened and comes to bear against the carrier and at the same time continuously reduces the size of the orifice and continuously reduces the passage within the defined pressure range.

In one design variant, the passage comprises at least two orifices lying next to one another and the carrier comprises a web which separates the orifices lying next to one another from one another. In this case, the spring tongue is arranged such that, with a rising differential pressure, it lies increasingly on the web and continuously reduces the orifices, the orifices remaining open in defined remaining ranges.

In a further design variant, the passage comprises a plurality of orifices arranged in a rotationally symmetrical manner and the flatform spring comprises a plurality of spring tongues which are arranged in a rotationally symmetrical manner and are in each case arranged such that, with a rising differential pressure, they lie increasingly on the carrier and continuously reduce, that is to say increasingly cover, the orifices.

In a preferred design variant, the flatform spring has at least two spring tongues oriented in directions opposite to one another along a common longitudinal axis.

In various design variants, the spring tongues are fastened to an outer marginal region of the carrier, in the center of the carrier or to a fastening web running through the center.

In one design variant, the carrier is configured as a round disk which comprises at the outer marginal region a set-up collar for insertion into a pipeline, for example into a connection piece between two pipelines or into a valve, for example a ball valve or a lifting valve.

In addition to the flow limiter, the present invention also relates to a method for limiting a volumetric flow through a liquid line.

### BRIEF DESCRIPTION OF THE DRAWINGS

An embodiment of the present invention is described below by means of an example. The exemplary embodiment is illustrated by the following accompanying figures:

FIG. 1a shows a view of a flow limiter with a flatform spring which is configured as a spring tongue and which is attached via two orifices separated from one another by a web.

FIG. 1b shows a cross section of the flow limiter of FIG. 1a installed in a liquid line.

FIG. 1c shows a top view of the flow limiter of FIG. 1a installed in a liquid line.

FIG. 2a shows a view of a flow limiter with a flatform spring which has a plurality of spring tongues which are arranged in a rotationally symmetrical manner and are fastened, centered, and which are attached over a plurality of orifices, in each case separated from one another by a web.

FIG. 2b shows a cross section of the flow limiter of FIG. 2a installed in a liquid line.

FIG. 2c shows a top view of the flow limiter of FIG. 2a installed in a liquid line.

FIG. 3a shows a view of a flow limiter with a flatform spring which has a plurality of spring tongues which are arranged in a rotationally symmetrical manner and are fastened to the outer marginal region of the flow limiter and which are attached over a plurality of orifices in each case separated from one another by a web.

FIG. 3b shows a cross section of the flow limiter of FIG. 3a installed in a liquid line.

FIG. 3c shows a top view of the flow limiter of FIG. 3a installed in a liquid line.

FIG. 4 shows a cross section of the flow limiter with a low differential pressure and a correspondingly slightly deflected spring tongue, and a curve which illustrates the nonlinear dependence of deflection and spring force.

FIG. 5 shows a cross section of the flow limiter with a high differential pressure and a correspondingly highly deflected spring tongue, and a curve which illustrates the nonlinear dependence of deflection and spring force.

FIG. 6 illustrates diagrammatically the rate profile of the volumetric flow rate through the flow limiter.

FIG. 7 shows a cross section through a lifting valve with an installed flow limiter in the liquid supply line.

FIG. 8 shows a cross section through a ball valve with an installed flow limiter in the liquid supply line.

FIG. 9a shows a view of a flow limiter with a flatform spring which has two spring tongues which are fastened to the fastening web running transversely over the flow limiter between the outer marginal regions and which are attached in each case above two orifices separated from one another by a web.

FIG. 9b shows another view of the flow limiter of FIG. 9a.

FIG. 9c shows a cross section of the flow limiter of FIG. 9a installed in a liquid line.

FIG. 9d shows a top view of the flow limiter of FIG. 9a installed in a liquid line.

FIG. 10 shows a top view of a flow limiter with a flatform spring which has four spring tongues which are arranged in a rotationally symmetrical manner and are fastened at the center of the flow limiter and which are attached in each case via an assigned web which separates two orifices from one another, in each case assigned to a spring tongue.

FIG. 11 shows a top view of a further flow limiter with a flatform spring according to FIG. 9, the two spring tongues of which are attached in each case via two assigned webs which flatform spring separates the passage into three orifices in each case assigned to a spring tongue.

FIG. 12a shows a cross section of a flow limiter with a body which precedes the flatform spring and which shields the flatform spring from the direct impingement of the flow in the case of a low differential pressure.

FIG. 12b shows a top view of the flow limiter of FIG. 12a.

FIG. 12c shows a 3D view of the flow limiter of FIG. 12a.

FIG. 13a shows a cross section of a flow limiter with a flatform spring, the spring tongues of which are oriented in the direction of flow, in order to offer a reduced attack surface in the case of a low differential pressure of the flow.

FIG. 13b shows a top view of the flow limiter of FIG. 13a.

FIG. 13c shows a 3D view of the flow limiter of FIG. 13a.

Ways of implementing the invention

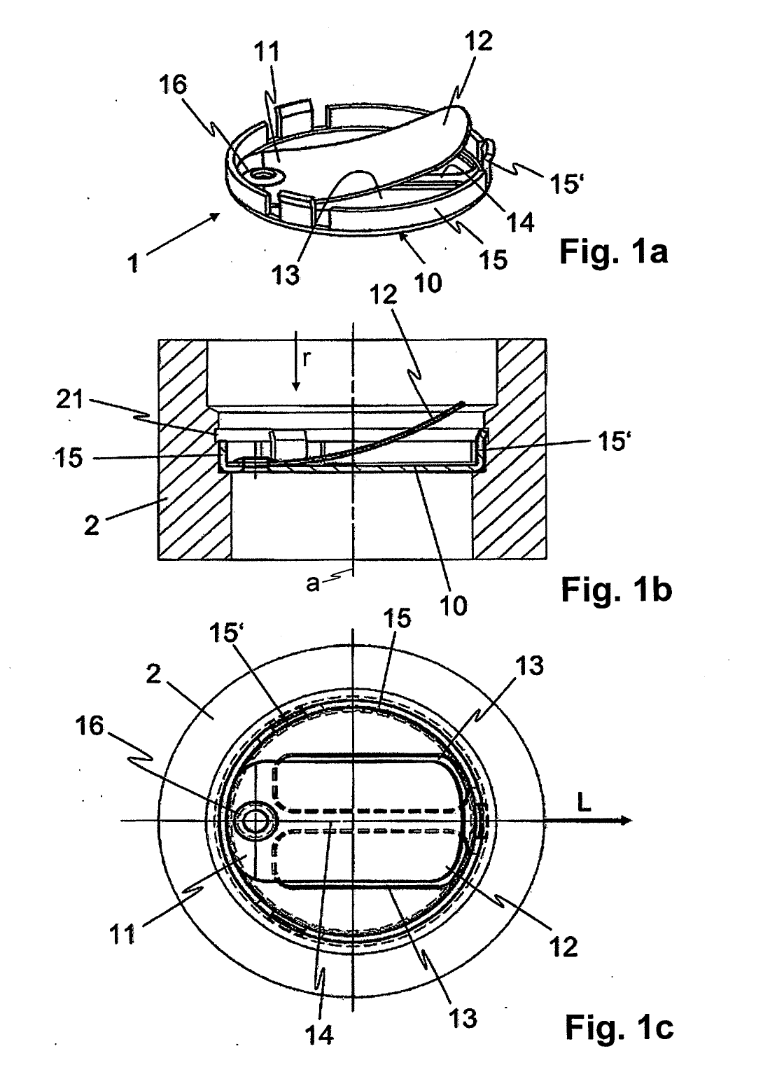

In FIGS. 1a, 2a, 3a, 4, 5, 7, 8, 9a, 9b, 10, 11, 12a, 12b, 12c, 13a, 13b and 13c, reference symbol 1 denotes a flow limiter which is also designated as a flow rate controller and limits the volumetric flow through a liquid line 2 within a defined working range (Δpₘᵢₙ, Δpₘₐₓ) of the differential pressure Δp. A pressure-independent volumetric flow \dot{V} is achieved in that the passage of the flow limiter 1, that is to say the throughflow cross section or the throughflow area, is reduced in dependence on the force generated from the differential pressure Δp. For this purpose, the flow limiter 1 comprises a flatform spring 11 which has a defined radius (of the order of magnitude of the liquid line 2, for example of the order of magnitude of the pipe diameter) and which is fastened to a carrier 10 of the flow limiter 1 and is arranged above the passage orifices 13, 18, 23, 23′ of the flow limiter 1 such that with an increasing pressure Δp it increasingly covers and closes the variable orifice area, in other words the passage of the flow limiter 1. In this case, the flatform spring 11 comes to bear increasingly against the carrier 10, for example on a web 14, 24 and/or on side margins 29 of the orifices 18, with the result that the flatform spring 11 becomes increasingly hard. The flatform spring 11 becomes harder because its effective length is reduced due to the fact that it lies increasingly against the carrier 10. Thus, the passage and therefore the throughflow are regulated in a directed manner even at a higher differential pressure Δp and are kept substantially constant within a specific working range [Δpₘᵢₙ, Δpₘₐₓ]. The passage orifices are in each case formed as perforations in the carrier 10.

As is clear in FIGS. 1a, 1b, 1c, 2a, 2b, 2c, 3a, 3b, 3c, 9a, 9b, 9d, 10, 11, 12b and 12c, the carrier 10 preferably has a round configuration to fit the cross section of the liquid line 2 and has a projecting collar 15. The collar 15 is attached to the outer marginal region of the disk-shaped carrier 10 and is produced, for example, by compressive strain, in one piece with the carrier 10. In one variant, the collar has a plurality of portions 15′ which are spread slightly and engage into corresponding receptacles 21, for example a groove, in the wall of the liquid line 2 and fix the flow limiter 1 axially in the liquid line 2.

In one design variant (not illustrated), part of the collar 15 is bent back onto the carrier 10 and firmly clamps the flatform spring 11 to the carrier 10. However, the flatform spring 11 may also be fastened to the carrier 10 by means of a rivet 16 or by adhesive bonding.

In the design variant according to FIGS. 1a, 1b and 1c, the flatform spring 11 comprises a spring tongue 12 and the carrier 10 has a passage with two orifices 13 lying next to one another. As is clear from FIG. 1c, the two orifices 13 and the spring tongue 12 have an essentially identical extent (length) in the longitudinal direction L. The carrier 10 has a web 14 which separates the two orifices 13 from one another. The flatform spring 11 is attached to the outer marginal region of the round carrier 10. The two orifices 13 are rectangular or trapezoidal and extend from the outer marginal region, where the flatform spring 11 is fastened, as far as the opposite outer marginal region of the carrier 10. The flatform spring 11 or the spring tongue 12 is oriented along (parallel to) the orifices 13 along the longitudinal axis of the web 14 and is arranged above the orifices 13 such that, when it comes to bear increasingly on the web 14 of the carrier 10 with a rising differential pressure Δp, it increasingly and continuously covers and closes the orifices 13 within the defined working range [Δpₘᵢₙ, Δpₘₐₓ] until, when the spring tongue 12 comes to bear to the maximum, a minimum passage remains. The minimum passage is formed by remaining regions which remain open in marginal regions, facing away from the web 14, of the orifices 13 and which are not covered by the spring tongue 12.

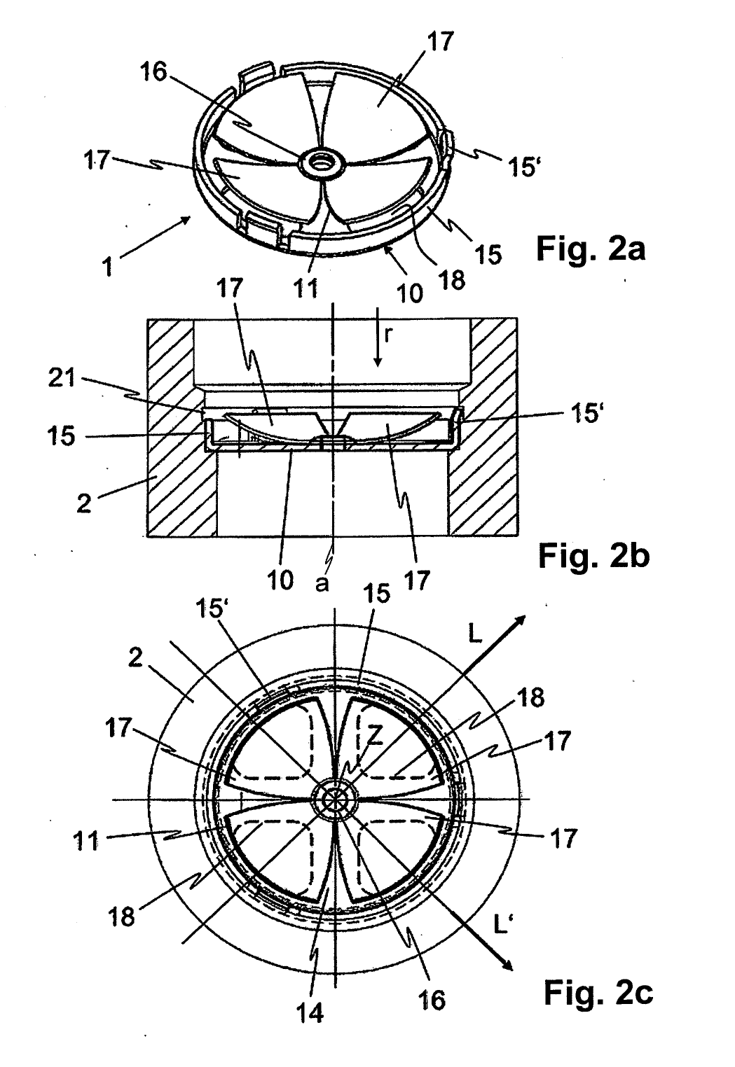

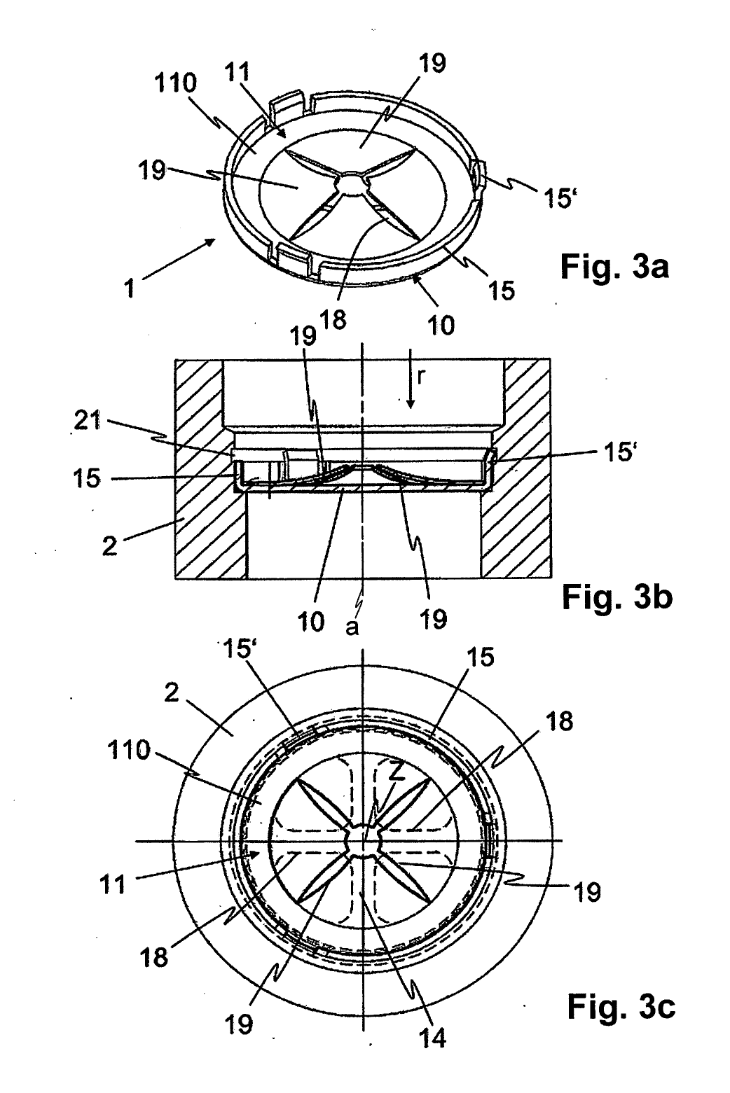

In the design variant according to FIGS. 2a, 2b, 2c, 3a, 3b and 3c, the carrier 10 has a passage with four orifices 18 which are arranged in a rotationally symmetrical manner and are in each case separated from one another by a web 14. As is clear in FIGS. 2c and 3c, the webs 14 may be considered as spokes of a wheel which is formed from the round carrier 10 by the orifices 18. The orifices 18 are in each case designed as approximately triangular circle sectors of the round carrier 10 which do not extend completely as far as the center of the carrier 10. The flatform spring 11 comprises a plurality of spring tongues 17, 19 which are arranged in a rotationally symmetrical manner and are in each case arranged such that, with a rising differential pressure, they lie increasingly on the carrier 10 and continuously reduce the orifices 18.

In the design variant according to FIGS. 2a, 2b and 2c, the flatform spring 11 is attached in the center Z of the carrier 10 and the spring tongues 17 are in each case assigned to an orifice 18. As is clear from FIG. 2c, the orifices 18 and the spring tongues 17 have an essentially identical extent (length) along the longitudinal direction L, L′. The spring tongues 17 are in each case arranged above an assigned orifice 18 such that, with a rising differential pressure Δp, they in each case lie increasingly on the two webs 14 which delimit the respective orifice 18. Thus, the orifices 18 are increasingly and continuously covered and closed within the defined working range [Δpₘᵢₙ, Δpₘₐₓ], until, when the spring tongue 17 comes to bear to the maximum, a minimum passage remains. As regards the orifices 18, the minimum passage is formed in each case by a remaining region, remaining open, in marginal regions of the orifices 18, which marginal regions face away from the center Z and are not covered by the spring tongues 17.

In the design variant according to FIGS. 3a, 3b and 3c, the flatform spring 11 has an outer hoop region 110 which is attached to the carrier 10. In contrast to the design variant according to FIGS. 2a, 2b and 2c, the spring tongues 19 are therefore fastened to the outer marginal region of the carrier 10.

As is clear from FIG. 3c, the orifices 18 and spring tongues 19 have an essentially identical extent (length) from the hoop region 110 to the center Z along their longitudinal direction, that is to say along their respective axis of symmetry. The spring tongues 19 are in each case arranged above an assigned web 14 such that, with a rising differential pressure Δp, in each case they lie increasingly on the respective web 14 and increasingly cover the two orifices 18 adjacent to the web 14. Thus, the orifices 18 are increasingly and continuously covered and closed within the defined working range [Δpₘᵢₙ, Δpₘₐₓ], until, when the spring tongue 19 comes to bear to the maximum, a minimum passage remains. As regards the orifices 18, the minimum passage is formed in each case by a region which remains open between two adjacent spring tongues 19 along the axis of symmetry of the respective orifice and which is not covered by the spring tongues 19.

A person skilled in the art will understand that even three or more than four orifices 18 and corresponding spring tongues 17, 19 may be provided.

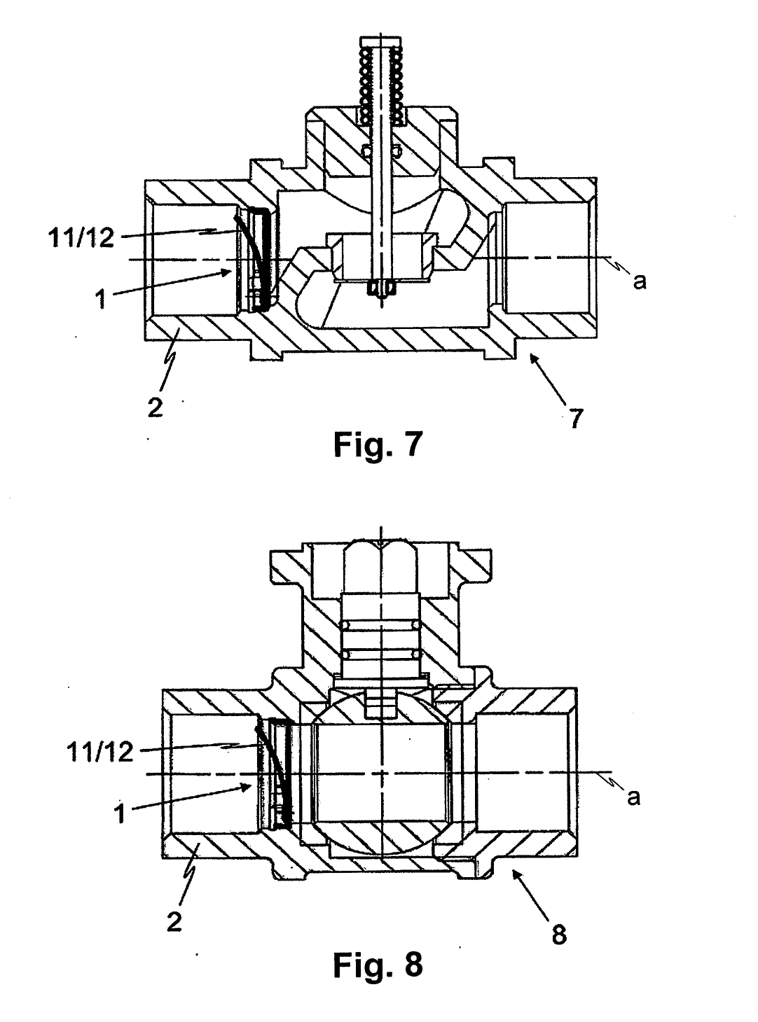

FIG. 7 shows a cross section through a lifting valve 7 with a removably or fixedly installed flow limiter 1 (according to one of the design variants described) in the liquid supply line 2.

FIG. 8 shows a cross section through a ball valve 8 having a removably or fixedly installed flow limiter 1 (according to one of the design variants described) in the liquid supply line 2.

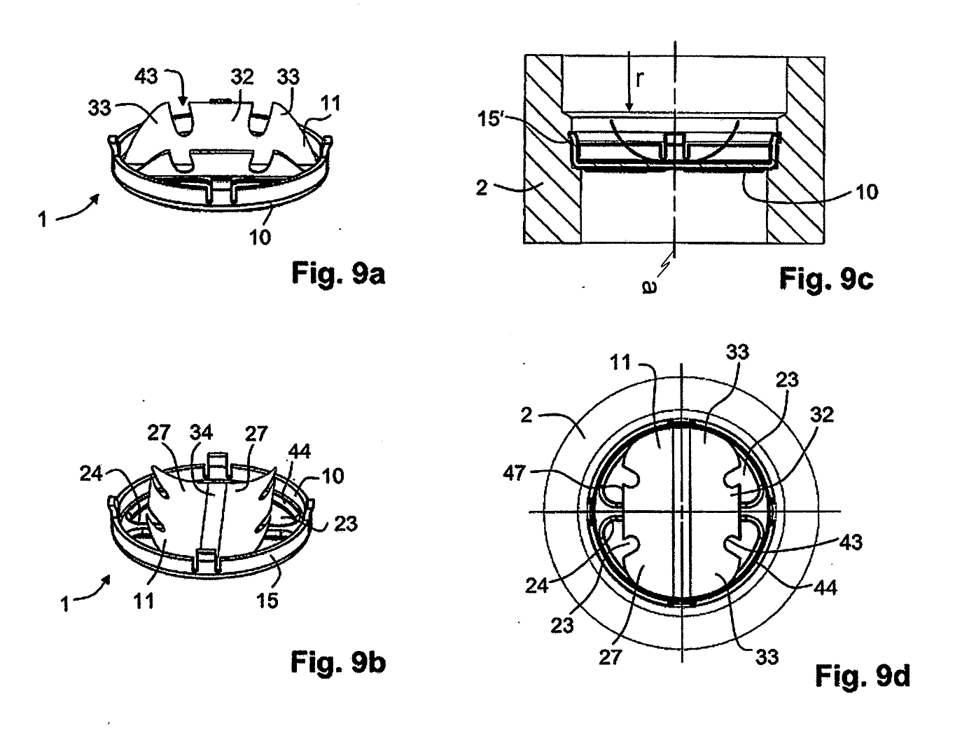

FIGS. 9a, 9b, 9c and 9d show views, a cross section and top views of a flow limiter 1 with a flatform spring 11 which has two spring tongues 27 fastened to a fastening web 34 which runs transversely over the flow limiter 1 between the outer marginal regions. In this case, the fastening of the spring 11 on the web 34 may be adhesively bonded, riveted or configured according to the other fastening methods mentioned above. Each part region of the spring 11, that is to say each spring tongue 27, is in each case attached above two orifices 23 separated from one another by a web 24. The orifices therefore take up in each case approximately, minus the webs 24 and 34, a quadrant of the circular passage for the flow limiter 1.

It is clear in the cross section of FIG. 9c in the initial position, that is to say without a fluid flow, that the spring tongues 27 have a tangential angle between 10 and 30 degrees with respect to the longitudinal axis a of the liquid line 2. With the rising fluid flow, this curvature diminishes and, in particular, the middle part 32 of the spring tongue 27 is deposited onto the web 24, while the lateral parts of the spring tongues 27 are deposited on the marginal regions 44 of the carrier.

Between the middle part 32 and lateral parts 33 of the spring tongues 27 there are recesses 43 which may be implemented, in particular, as punched-out portions. These correspond, in the top view, to half an ellipse or to an ovally rounded slot. However, the recesses 43 are introduced into the marginal region of the spring tongues 27 preferably with smoother transitions than illustrated. If the angle 0 degrees is assigned in the radial direction to the mid-axis of a spring tongue 27 which is arranged above the web 24, these two recesses of a spring tongue 27 are arranged at an angle between 20 and 45 degrees, in particular at approximately 30 degrees.

The flatform spring 11, when flattened, and not in the pre-bent form illustrated in FIG. 9c, is not a complete circular disk, but instead is cut off, in particular, in the region of the middle part 32. The cut-off edge corresponds to a chord 47 of the circle. This chord 47 may merge into the circular margin of the spring 11 in a rounded manner in the lateral parts 33. Thus, when the spring 11 lies completely on the webs 24 and 34, a remaining double passage is obtained. This, on the one hand, is the region of the recesses 43 and, on the other hand, the space for the two orifices 23 which remains on the far side of the chord 47. It is clear that, in an exemplary embodiment not illustrated in the drawings, on one hand, only the recesses 43 may be present and, on the other hand, only the remaining space for the two orifices 23 which is predetermined by the chords may be present.

Here, too, the collar 15 has a plurality of portions 15′ which are spread slightly and can fix the flow limiter 1 axially in the liquid line 2.

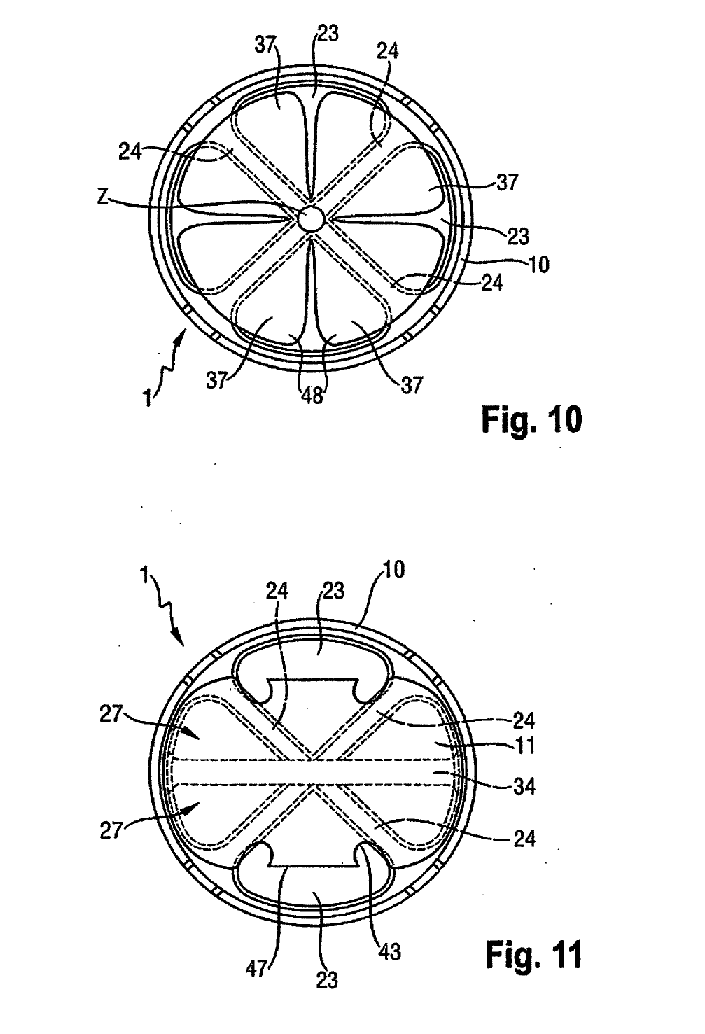

FIG. 10 shows a top view of a flow limiter 1 with a flatform spring 11 which has four spring tongues 37 arranged in a rotationally symmetrical manner and fastened at the center Z of the flow limiter 1. These spring tongues 37 are rotated through 45 degrees with respect to the exemplary embodiment of FIG. 2, so that they are attached in each case above an assigned web 24 which separates from one another two orifices 23 assigned in each case to a spring tongue 37. Conversely, here, each orifice 23 is in each case assigned two spring tongues 37. The passage regions remaining free arise here from the cloverleaf-like intermediate orifices between the spring tongues 37. In another exemplary embodiment, not illustrated in the drawings, the corners 48 of the spring tongues may be cut off in order to form more extensive recesses, or there may be recesses corresponding to the oval punched-out portions according to the exemplary embodiment of FIG. 9.

FIG. 11 shows a top view of a further flow limiter 1 with a flatform spring 11 which is modified in relation to FIG. 9, and the two spring tongues 27 of which are attached in each case above two assigned webs 24. The webs 24 intersect at the center at a 90 degree angle to one another and at a 45 degree angle to the fastening web 24. Here, therefore, the passage is divided into three orifices 23 assigned in each case to a spring tongue 27. Recesses 43 and the chord portion 47 correspond to those of FIG. 9, so that, in particular, the remaining passage region remains open in the middle portion 32, while the lateral spring tongue regions are deposited on the marginal region 44 of the carrier 10. It is also possible, however, that the recesses 43 are also or only or additionally provided in the lateral regions 33.

The flatform spring 11 is preferably made from a spring steel which, depending on the variant, has a straight or pre-bent configuration, particularly in the range of between approximately 30 degrees, as in the exemplary embodiments of FIGS. 1, 2 and 3, or up to 80 degrees, as in the exemplary embodiments of FIGS. 9 and 11. The width of the webs 14 and 24 is configured so as to form a reliable mechanical bearing surface. For this purpose, a width of 5 to 10%, at most 20%, of the diameter of the flow limiter 1 or of the width, projecting on both sides of the flatform spring 11 is sufficient.

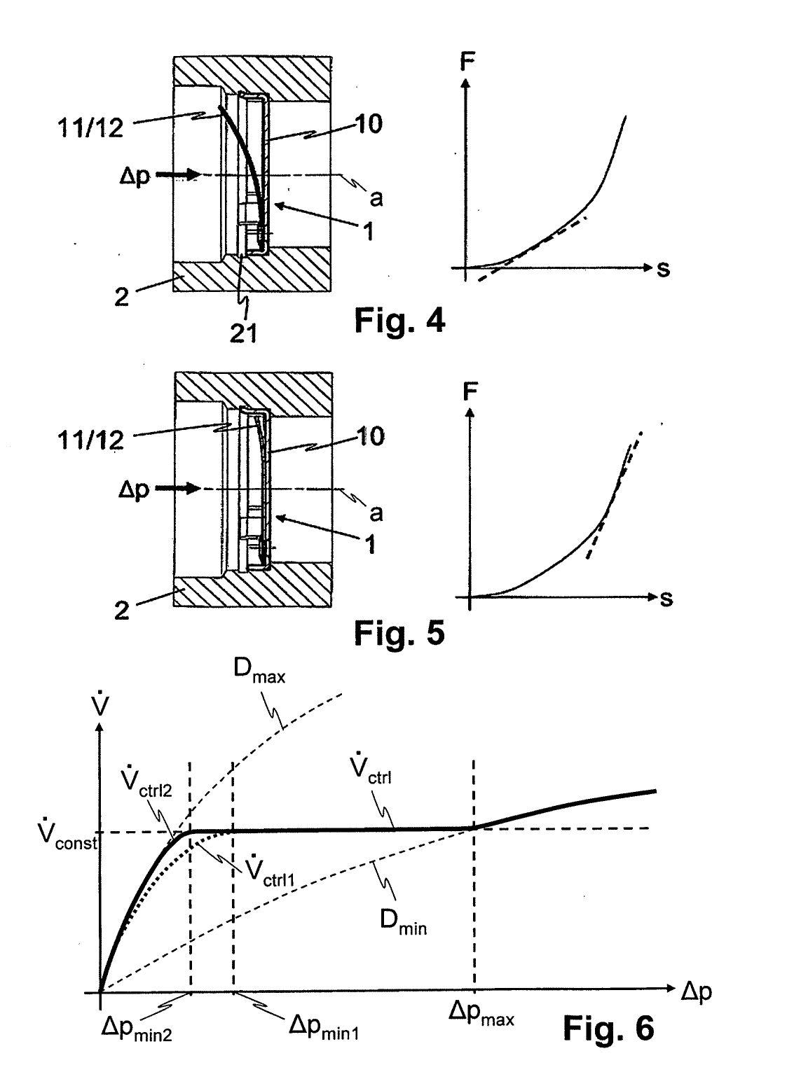

The nonlinear relation between spring force F and deflection s is illustrated in FIGS. 4 and 5. FIG. 4 shows a relatively slight deflection s of the flatform spring 11 or of a spring tongue 12, 17, 19, 27 of the flatform spring 11 in a range with a low pressure difference Δp and with a correspondingly low spring force F. FIG. 5 shows the comparatively high deflection s of the flatform spring 11 or of the spring tongue 12, 17, 19, 27 in a range with a relatively high pressure difference Δp and with correspondingly high spring force F increasing to a greater extent.

In FIG. 6, Dₘₐₓ denotes the (rate) profile of the volumetric flow \dot{V} through the flow limiter 1 in dependence on the differential pressure Δp in the case of a maximum uncontrolled passage (completely open passage orifice). Reference symbol Dₘᵢₙ designates the (rate) profile of the volumetric flow \dot{V} through the flow limiter 1 in dependence on the differential pressure Δp in the case of a minimum passage which remains open (open remaining region with the passage orifice closed to the maximum) when the flatform spring or spring tongue 12, 17, 19, 27 comes to bear completely. As is clear from FIG. 6 the controlled (rate) profile of the volumetric flow \dot{V}_{ctrl} follows the bold unbroken line which assumes an essentially constant volumetric flow value \dot{V}_{const} in the working range, between the minimum differential pressure Δpₘᵢₙ₂ and the maximum differential pressure Δpₘₐₓ, below the minimum differential pressure Δpₘᵢₙ₂ follows essentially the profile Dₘₐₓ of the volumetric flow \dot{V} in the case of an uncontrolled maximum passage, and, above the maximum differential pressure Δpₘₐₓ, follows the profile Dₘᵢₙ of the volumetric flow \dot{V} in the case of a minimum (that is to say, maximum covered) passage. In this case, the part, designated by \dot{V}_{ctrl2}, of the controlled (rate) profile of the volumetric flow \dot{V}_{ctrl} constitutes, up to the differential pressure Δpₘᵢₙ₁, an improvement in relation to the (rate) profile, designated by \dot{V}_{ctrl1} and indicated by dashes, of the volumetric flow \dot{V}_{ctrl}. As compared with the profile \dot{V}_{ctrl1} indicated by dashes, the improved profile \dot{V}_{ctrl2} has a working range [Δpₘᵢₙ₂, Δpₘₐₓ] extended in the lower pressure range [Δpₘᵢₙ₂, Δpₘᵢₙ₁] and having a constant volumetric flow value \dot{V}_{const}. In the profile indicated by dashes, a constant volumetric flow value \dot{V}_{const} is present only in the smaller range [Δpₘᵢₙ₁, Δpₘₐₓ]. This marked improvement for low values of the differential pressure Δp below the differential pressure Δpₘᵢₙ₁ is achieved in that, in the case of low differential pressure values Δp (that is to say, in particular, in the essentially deflection-free initial position), the flatform spring 11 or the spring tongue 12, 17, 19, 27, 27′ is exposed to the direct flow to a lesser extent. As a result, in the case of low differential pressure values Δp, the flatform spring 11 or spring tongue 12, 17, 19, 27, 27′ is deflected or brought to bear against the carrier 10, 10′ to a lesser extent, and consequently the passage is reduced less (quickly) at low differential pressure values Δp, so that the nominal throughflow, that is to say the constant volumetric flow value \dot{V}_{const}, is obtained even at a lower differential pressure Δpₘᵢₙ₂ and therefore an extended working range [Δpₘᵢₙ₂, Δpₘₐₓ] with a constant volumetric flow value \dot{V}_{const} is achieved.

Depending on the design variant, the reduced flow exposure of the flatform spring 11 or the spring tongue 12, 17, 19, 27, 27′ is achieved in that the spring tongue 12, 17, 19, 27, is preceded by a body in order to shield the spring tongue 12, 17, 19, 27 from the direct impingement of the flow, or in that the majority of the orientation of the spring tongue 12, 17, 19, 27′ is in the direction of flow r in order to offer a reduced attack surface to the flow.

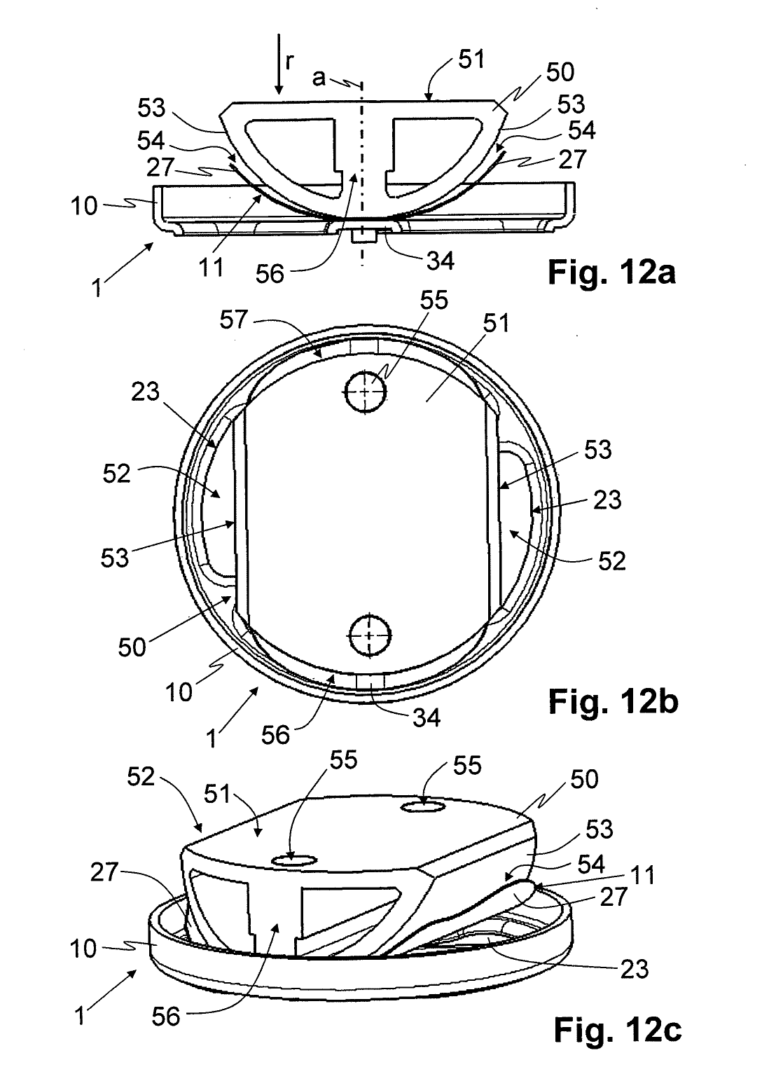

FIGS. 12a, 12b and 12c illustrate a design variant of the flow limiter 1 with a flatform spring 11 and with a body 50 which precedes the latter in the direction of flow r and which is attached to the carrier 10. The body 50 generates a flow shadow for at least a part region of the flatform spring 11 or of the spring tongues 27, and in this case the flow shadow (as in a light source) is to be understood as an (idealized) projection shadow and any vortex effects are not taken into account. The body 50 preferably shades the flatform spring 11 or spring tongues 27 completely from the direct impingement of the flow and generates 100% flow shadow, that is to say a projection shadow, as is clear in the top view of FIG. 12b where the flatform spring 11 is covered completely by the body 50 in the axial direction (of flow) of the liquid line 2. Bodies 50 which generate a proportionally smaller flow shadow are also possible, especially when only the more rigid part of the spring tongue 27 in the fastening region of the flatform spring 11 is not shaded. The body 50 is preferably made from plastic and has a screening surface 51 which faces the flow and faces away from the flat spring 11 and which runs perpendicularly with respect to the axial direction of the liquid line 2 and generates the flow shadow. The screening surface 51 preferably has a basic form which corresponds to the inner cross section of the liquid line 2 and which has one or more recesses serving as supply regions 52. FIGS. 12a, 12b and 12c show the preceding body 50 in combination with a flow limiter 1 according to FIGS. 9a, 9b, 9c and 9d. However, a person skilled in the art would understand that a body 50 formed according to the respective variant may also precede the flatform spring 11 or the spring tongues 12, 17, 19, 27 in other designs of the flow limiter 1 according to FIGS. 1a, 1b, 1c, 2a, 2b, 2c, 3a, 3b, 3c, 10 and/or 11. The screening surface 51 has, for example, a circular basic form which, in the embodiments of the flow limiter 1 according to FIGS. 1a, 1b, 1c, 2a, 2b, 2c, 9a, 9b, 9c, 9d, 10 and 11, is reduced by circle segments arranged in the supply regions 52 and, in the embodiments of the flow limiter 1 according to FIGS. 3a, 3b and 3c, has a, for example, circular recess to a central supply duct through the body 50 to the spring tongues 19. The body 50 has, for example, bent supply walls 53 which face the flatform spring 11 and extend essentially in the supply regions 52, from the screening surface 51 of the body 50 to the fastening side, facing away from the screening surface 51, of the body 50. With an increasing differential pressure Δp, fluid streams are conducted through the supply region 52 along the supply walls 53 into supply gaps 54 which are formed essentially in a wedge-shaped manner between the supply walls 53 and the spring tongue 12, 17, 19, and which are enlarged with an increasing differential pressure Δp and consequently an increasing deflection of the spring tongue 12, 17, 19, 27. In the embodiments of the flow limiter 1 according to FIGS. 1a, 1b, 1c, 2a, 2b, 2c, 9a, 9b, 9c, 9d, 10 and 11, the supply walls 53 taper the body 50 essentially from the outer marginal region of the screening surface 51 of the body 50 to the fastening side of the body 50, for example, in arcuate form, and in the variants according to FIGS. 2a, 2b, 2c, 9a, 9b, 9c, 9d, 10 and 11, increasingly toward the center Z of the carrier 10. In the embodiments of the flow limiter 1 according to FIGS. 3a, 3b and 3c, the supply walls 53 prolong the supply duct through the body 50 essentially from the screening surface 51 of the body 50 to the fastening side of the body 50 increasingly toward the outer marginal region of the carrier 10, for example in arcuate form. The body 50 is fastened, for example, together with the flatform spring 11, to the carrier 10 by means of a rivet, for example by rivet holes 50, or by adhesive bonding.

In the design variant of the flow limiter 1 according to FIGS. 12a, 12b, 12c, which, like the variants according to FIGS. 9a, 9b, 9c, and 9d, has a double-tongued flatform spring 11, the body 50 is based, for example, on a cylindrical basic form, the lateral area of which is formed by the bent supply walls 53 and the screening surface 51 and the base and top area 56, 57 of which have a configuration essentially in the form of a circle segment, the screening surface 51 running through the circle chords and the supply walls 53 running through the circle arc of the base and top area 56, 57. In the case of a (circularly) round configuration of the carrier 10, the base and top areas 56, 57 are of correspondingly round form, that is to say the body 50 has rounded base and top areas 56, 57 which are arranged in each case perpendicularly to the screening surface 51 and which make it possible for the body 50 to be inserted into the ring formed by the collar 15. The body 50 is, for example, of hollow configuration and is provided with orifices on the base and top areas 56, 57. As is clear in FIG. 12a, the body 50 and the flatform spring 11 are attached to a fastening web 34.

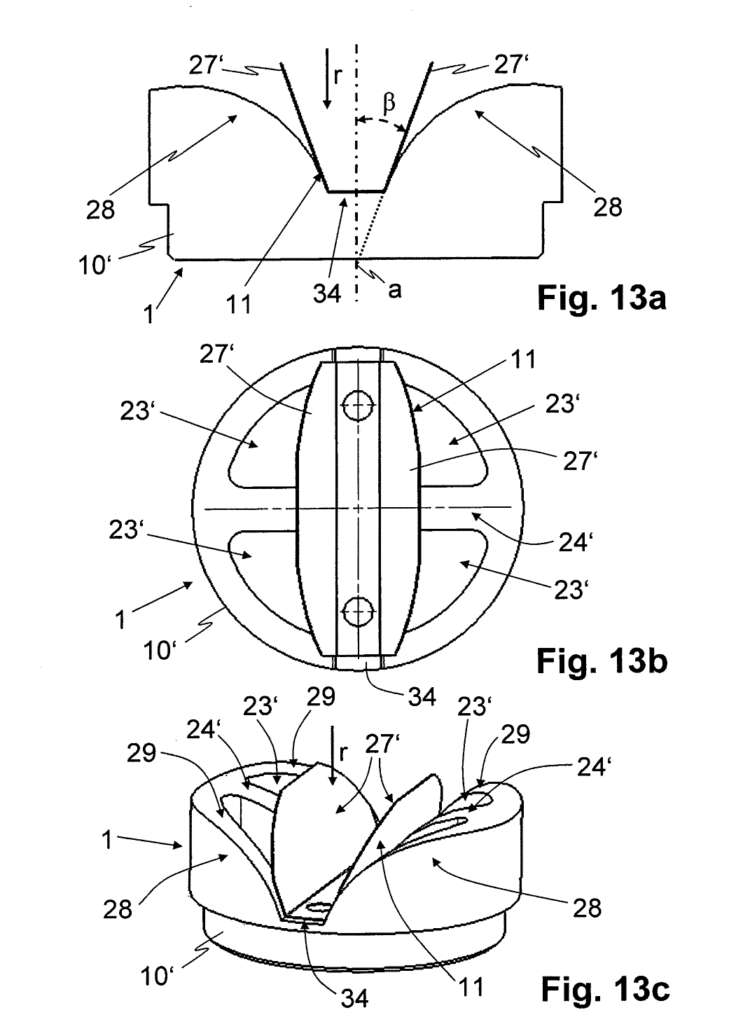

FIGS. 13a, 13b and 13c illustrate a design variant of the flow limiter 1 in which the (double-tongued) flatform spring 11 or the spring tongues 27′ in the initial position, that is to say without a fluid flow and with low differential pressure values Δp, are in each case of non-bent form, that is to say of a form stretched out flat, and are oriented in the majority in the direction of flow r. That is to say, the spring tongues 27′ run in each case straight and for the most part in the direction of flow r and have in each case an angle β of less than 45°, preferably an angle β of between 5° and 15°, with respect to the longitudinal axis a of the liquid line 2, as is clear in the cross section of FIG. 13a. As a result, the spring tongues 27′ offer a reduced attack surface to the flow at low differential pressure values Δp. Even smaller angles β between the spring tongues 27′ and the longitudinal axis a of the liquid line 2 are possible but, depending on the rigidity of the spring tongues 27′, there is the risk that, if the angle β is too small, undesirable oscillation and/or bending round of the spring tongue 27′ into the wrong direction (not the desired direction) will occur. FIGS. 13a, 13b, and 13c show the flow limiter 1 in a design variant which corresponds in the top view essentially to the embodiment according to FIGS. 9a, 9b, 9c and 9d, although the set-out spring tongues 27′ form essentially a V-shaped cross section. However, a person skilled in the art will understand that, even on the basis of other designs of the flow limiter 1 according to FIGS. 1a, 1b, 1c, 2a, 2b, 2c, 3a, 3b, 3c, 10 and/or 11, the flatform spring 11 or the spring tongues 12, 17, 19, 27 and the carrier 10 can be adapted according to the embodiment described below with reference to FIGS. 13a, 13b and 13c. In particular, the spring tongues 12, 17, 19, 27 can also be set up and formed such that, in the initial position, they are stretched out straight and have an angle β of less than 45°, preferably an angle β of between 15° and 25°, with respect to the longitudinal axis a of the liquid line 2. Moreover, the carrier 10, having an essentially identical top view, that is to say with in horizontal projection essentially the same configuration of the webs and orifices, in the axial direction of the liquid line 2 (direction of flow r), can be adapted according to the carrier 10′ illustrated in FIGS. 13a, 13b and 13c. As illustrated in FIGS. 13a, 13b and 13c, that region of the carrier 11′ which lies beneath the spring tongue 27′ is in each case configured as a ramp 28 rising opposite to the direction of flow, for example with an arcuate cross section. It is clear in FIG. 13c, that the ramp 28 is formed by the web 24′ and the side regions 29 of the orifices 23′. The ramp 28 thus formed rises from the fastening region of the flatform spring 11 on the carrier 10′, in particular from the fastening web 34, opposite to the direction of flow, before it descends again slightly in the arcuate variant. In the embodiments of the flow limiter 1 according to FIGS. 1a, 1b, 1c, 2a, 2b, 2c, 9a, 9b, 9c, 9d, 10, 11, 12a, 12b, 12c, 13a, 13b and 13c, the ramp 28 in each case rises toward the outer marginal region of the carrier 10, 10′; in the embodiments of the flow limiter 1 according to FIGS. 3a, 3b and 3c, the ramp 28 rises in each case toward the center Z of the carrier 10. The spring tongue 27′ and the ramp 28 are designed such that, with an increasing differential pressure Δp, the spring tongue 27 is bent in the direction of the ramp 28, at the same time comes to bear increasingly against the ramp 28 and consequently increasingly reduces the passage. In this case, the angle β of the spring tongue 27′ with respect to the longitudinal axis a of the liquid line 2 is enlarged, and the flow-exposed attack surface of the spring tongue 27′ increases.

Finally, it should be noted that, by the flatform spring 11 or the spring tongues, 12, 17, 19, 27, 27′, 37 coming to bear increasingly against the carrier 10, 10′, the opening angle between the flatform spring 11 or the spring tongue or spring tongues 12, 17, 19, 27, 27′, 37 and the carrier 10, 10′ is reduced from a maximum value in the initial position in the deflection-free state, bent away from the carrier 10, 10′, of the flatform spring 11 or of the spring tongue or spring tongues 12, 17, 19, 27, 27′, 37 to a minimum value (typically zero) in the flattened state, lying on the carrier 10, 10′, of the flatform spring 11 or of the spring tongue or spring tongues 12, 17, 19, 27, 27′, 37. In this case, the flow cross section to which the flatform spring 11 or the spring tongue or spring tongues 12, 17, 19, 27, 27′, 37 offer a direct attack surface is increased in size with a rising differential pressure when the flatform spring 11 or the spring tongue or spring tongues 12, 17, 19, 27, 27′, 37 come to bear increasingly against the carrier 10, 10′.

1. A flow limiter (1) for limiting a volumetric flow through a liquid line (2), comprising a carrier (10, 10′) with a passage and a flatform spring (11) attached to the carrier (10, 10′), the flatform spring (11) having at least one spring tongue (12, 17, 19, 27, 27′, 37) and the passage having at least one orifice (13, 18, 23, 23′) and the spring tongue (12, 17, 19, 27, 27′, 37) being configured and arranged above the orifice (13, 18, 23, 23′) such that, with a rising differential pressure (Δp), the spring tongue (12, 17, 19, 27, 27′, 37) comes to bear increasingly against the carrier (10, 10′) and at the same time reduces the size of the orifice (13, 18, 23, 23′) and reduces the passage within a defined pressure range, characterized in that
the spring tongue (27) is preceded by a body (50) or the spring tongue (27′) is oriented in the direction of flow (r) such that the spring tongue (27, 27′) offers a direct attack surface to a flow cross section which is reduced by at least 25% and which increases in size with a rising differential pressure (Δp) when the spring tongue (12, 17, 19, 27, 27′, 37) increasingly comes to bear against the carrier (10, 10′).

2. The flow limiter (1) as claimed in claim 1, characterized in that the spring tongue (27) is preceded by a body (50) or the spring tongue (27′) is oriented in the direction of flow (r) such that the spring tongue (27, 27′) is exposed directly to a reduced flow cross-sectional part which amounts to less than a surface part of 75% of the spring tongue (27, 27′).

3. The flow limiter (1) as claimed in claim 1, characterized in that, at a low differential pressure (Δpₘᵢₙ₂) of the defined pressure range, the spring tongue (27′) is oriented in the direction of flow (r) such that the majority of the spring tongue (27′) runs in the direction of flow (r) and the spring tongue (27′) offers a direct attack surface to a reduced flow cross-sectional part which amounts to less than a surface part of 75% of the spring tongue (27′), in particular a surface part of between 8% and 25% of the spring tongue (27′).

4. The flow limiter (1) as claimed in claim 1, characterized in that, in a flow-free initial position, the spring tongue (27′) is of straight form and has an angle (β) of less than 45°, in particular an angle (β) in the range of 5° to 15°, with respect to a longitudinal axis (a) of the liquid line (2).

5. The flow limiter (1) as claimed in claim 1, characterized in that the carrier (11′) has a ramp (28) rising opposite to the direction of flow, and in that the spring tongue (27′) is configured such that, with a rising differential pressure (Δp), it is bent increasingly and comes to bear against the ramp (28), and at the same time continuously reduces the size of the orifice (23′) and continuously reduces the passage within the defined pressure range.

6. The flow limiter (1) as claimed in claim 1, characterized in that the body (50) preceding the spring tongue (27) is set up and arranged such that, at a low differential pressure (Δpₘᵢₙ₂) of the defined pressure range, it generates a flow shadow for at least a surface part of 25% of the spring tongue (27), in particular for a surface part in the range of 90% to 100% of the spring tongue (27).

7. The flow limiter (1) as claimed in claim 6, characterized in that the carrier (10) is in essentially planar configuration, and in that the spring tongue (27) is configured such that, with a rising differential pressure (Δp), it is increasingly flattened and comes to bear against the carrier (10) and at the same time continuously reduces the size of the orifice (23) and continuously reduces the passage within the defined pressure range.

8. The flow limiter (1) as claimed in claim 1, characterized in that the passage comprises at least two orifices (13, 18, 23, 23′) lying next to one another, in that the carrier (10,10′) comprises a web (14, 24, 24′) which separates the orifices (13, 18, 23, 23′) lying next to one another from one another, and in that the spring tongue (12, 17, 19, 27, 27′, 37) is arranged such that, with a rising differential pressure (Δp), it lies increasingly on the web (14, 24, 24′) and continuously reduces the orifices (13, 18, 23, 23′), the orifices (13, 18, 23, 23′) remaining open in defined remaining regions.

9. The flow limiter (1) as claimed in claim 1, characterized in that the passage comprises a plurality of orifices (18) arranged in a rotationally symmetrical manner, and in that the flatform spring (11) comprises a plurality of spring tongues (17, 19) which are arranged in a rotationally symmetrical manner and are in each case arranged such that, with a rising differential pressure (Δp), they lie increasingly on the assigned webs (14) and continuously reduce the size of the orifices (18).

10. The flow limiter (1) as claimed in claim 1, characterized in that the flatform spring (11) has at least two spring tongues (17, 19, 27, 27′) oriented in directions opposite to one another along a common longitudinal axis.

11. The flow limiter (1) as claimed in claim 1, characterized in that the spring tongues (12, 19) are fastened to an outer marginal region of the carrier (10).

12. The flow limiter (1) as claimed in claim 1, characterized in that the spring tongues (17, 27, 27′, 37) are fastened in the center (Z) of the carrier (10) or to a fastening web (34) running through the center (Z).

13. The flow limiter (1) as claimed in claim 1, characterized in that the spring tongues (12, 17, 19, 27, 27′, 37) and the orifice (13, 18, 23, 23′) have in each case an essentially identical extent along a longitudinal direction.

14. A method for limiting a volumetric flow through a liquid line (2), comprising: attaching a flatform spring (11) to a carrier (10, 10′) with a passage, providing the flatform spring (11) with at least one spring tongue (12, 17, 19, 27, 27′, 37) and providing the passage with at least one orifice (13, 18, 23, 23′), and configuring and arranging the spring tongue (12, 17, 19, 27, 27′, 37) above the orifice (13, 18, 23, 23′) such that, with a rising differential pressure (Δp), the spring tongue (12, 17, 19, 27, 27′, 37) comes to bear increasingly against the carrier (10, 10′) and at the same time reduces the size of the orifice (13, 18, 23, 23′) and reduces the passage within a defined pressure range, characterized by preceding the spring tongue (27) by a body (50) or arranging the spring tongue (27′) in the direction of flow (r) such that the spring tongue (27, 27′) offers a direct attack surface to a flow cross section which is reduced by at least 25% and which increases in size with a rising differential pressure (Δp) when the spring tongue (12, 17, 19, 27, 27′, 37) increasingly comes to bear against the carrier (10, 10′).

15. The method as claimed in claim 14, characterized in that the spring tongue (27) is preceded by a body (50) or the spring tongue (27′) is oriented in the direction of flow (r) such that the spring tongue (27, 27′) is directly exposed to a reduced flow cross sectional part which amounts to less than a surface part of 75% of the spring tongue (27, 27′).
